(19) United States
(12) Patent Application Publication
(10) Pub. No.: US 2013/0041486 A1
(43) Pub. Date: Feb. 14, 2013

(54) SYSTEM AND METHOD FOR CONTROLLING ELECTRICAL DEVICES

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/476,037

(22) Filed: May 21, 2012

(30) Foreign Application Priority Data
Aug. 11, 2011 (TW) 100128792

(51) Int. Cl. G05B 15/00

(52) U.S. Cl. 700/83

(57) ABSTRACT

A control computer provides a simulation scene of a monitored place and a setting interface for setting control instructions to control electrical devices and setting associations between the control instructions and the electrical devices. The electrical devices are connected to the control computer via a controller. A computing device downloads the simulation scene via a network, receives a selection operation on an electrical device and one or more control operations on control icons of the selected electrical device in the simulation scene, and sends the received information to the control computer. The control computer determines an electrical device connected to the controller and one or more associated control instructions according to the received information, and sends the one or more control instructions to the controller to control a status of the determined electrical device.

### BACKGROUND

1. Technical Field

The embodiments of the present disclosure relate to automatic control systems and methods, and more particularly to a system and a method for controlling electrical devices.

2. Description of Related Art

Multifunctional remote controllers can control multiple different electrical devices, such as televisions, refrigerators, air conditioners, for example. Often, a multifunctional remote controller has single control interface with multiple function buttons, and for controlling a particular electrical device, a user needs to perform preset operations using the buttons, to switch the multifunctional remote control to an operation mode of the particular electrical device. However, because switching between different operation modes of different electrical devices may happen frequently, the user should remember the preset operations or read an instruction book.

### BRIEF DESCRIPTION OF THE DRAWINGS

FIG. 1 is a block diagram of one embodiment of a system for controlling electrical devices.

FIG. 2 is a block diagram of function modules of a front-end system and a back-end system included by the system in FIG. 1.

FIG. 3 is one embodiment illustrates a setting interface provided by the back-end system in FIG. 2.

FIG. 4A-4C are one embodiment illustrate use of the front-end system and a simulation scene of a monitored place, which is downloaded from the back-end system.

FIG. 5 is one embodiment illustrates control operations for adjusting light brightness of a floor lamp via operating the simulation scene.

FIG. 6 is a flowchart of one embodiment of a method for controlling electrical devices.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

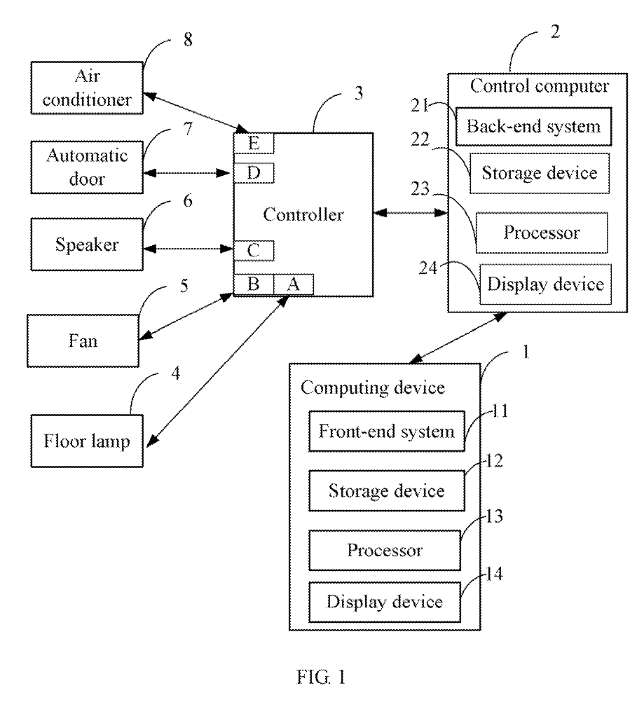

FIG. 1 is a block diagram of one embodiment of a system for controlling electrical devices. The system includes a front-end system 11 applied in a computing device 1 and a back-end system 21 applied in a control computer 2. The computing device 1 is connected to the control computer 2 via a wireless network or a wired network. The control computer 2 further electrically connects with a controller 3. The controller 3 has a plurality of connection interfaces, such as the interfaces A-E shown in FIG. 1, for connecting a plurality of electrical devices. As shown in FIG. 1, the electrical devices 1 may include a floor lamp 4, a fan 5, a speaker 6, an automatic door 7, and an air conditioner 8, which are arranged in a monitored place (such as a living room in a house). In this embodiment, the controller 3 may be a programmable automation controller (PAC) or a programmable logic controller (PLC).

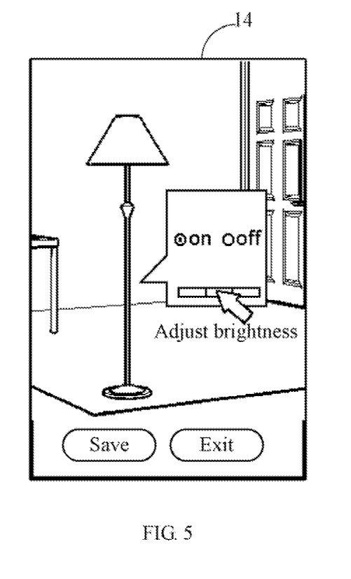

The computing device 1 further includes a storage device 12, a processor 13, and a display device 14. The control computer further 2 includes a storage device 22, a processor 23, and a display device 24. The storage device 22 stores simulation scenes of different monitored places and preset associations between control instructions and electrical devices in the simulation scenes. A simulation scene is a layout file that includes graphics and control icons of electrical devices arranged in a monitored place and controlled by the controller 3. The simulation scene may be two-dimensional or three-dimensional. The preset associations are defined as follows: when a corresponding operation is detected on a control icon (such as a brightness adjustment icon) of an electrical device (such as the floor lamp 4 in FIG. 5) in the simulation scene, a control instruction, which is associated with the electrical device and stored in the storage device 22, will be sent to and executed by the controller 3 to control the electrical device.

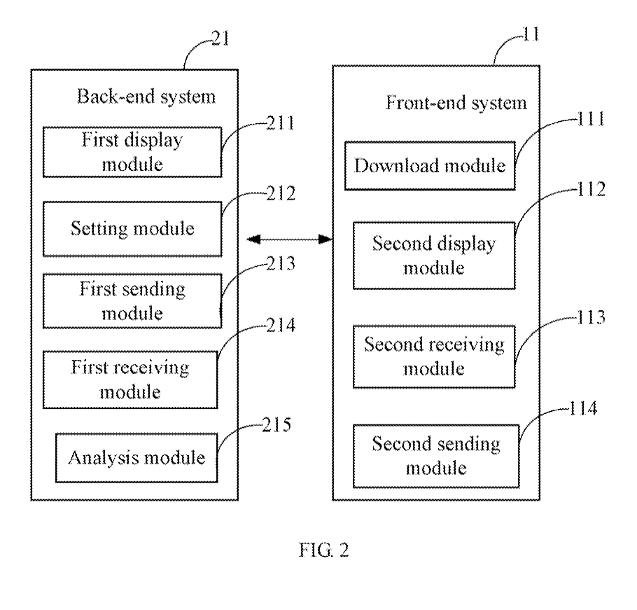

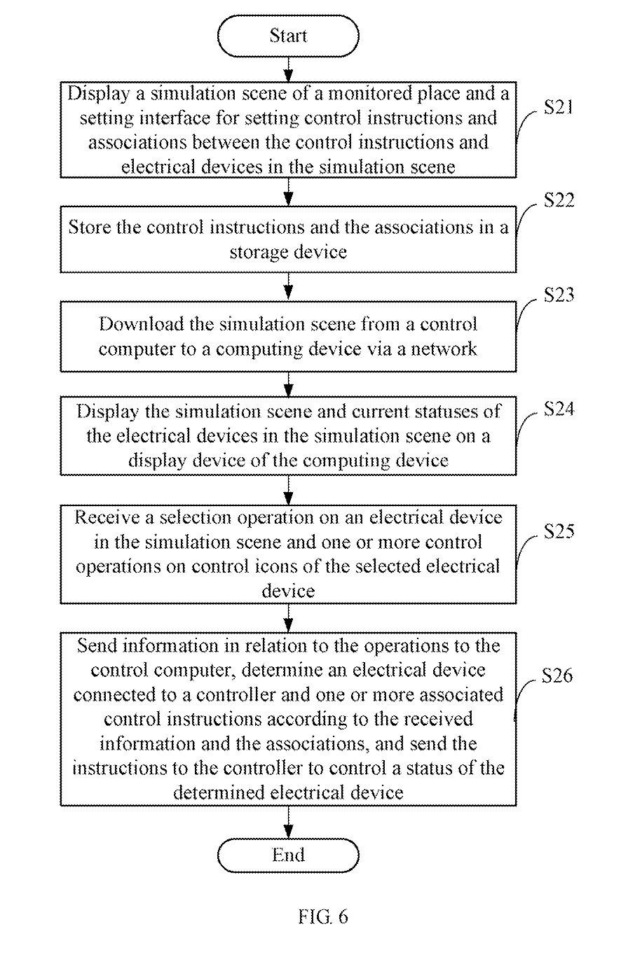

As shown in FIG. 2, the back-end system 21 includes a first display module 211, a setting module 212, a first sending module 213, a first receiving module 214, and an analysis module 215. The modules 211-215 may comprise computerized code in the form of one or more programs that are stored in the storage device 22 and to be executed by the processor 23 of the control computer 2. The front-end system 11 includes a download module 111, a second display module 112, a second receiving module 113, and a second sending module 114. The modules 111-114 may comprise computerized code in the form of one or more programs that are stored in the storage device 12 and to be executed by the processor 13 of the computing device 1. A detailed description of the functions of the modules 111-114 and 211-215 is given in FIG. 6. The storage device 12 or 22 may be a cache or a dedicated memory, such as an erasable programmable read only memory (EPROM), a hard disk driver (HDD), or a flash memory.

FIG. 6 is a flowchart of one embodiment of a method for controlling multifunctional electrical devices. Depending on the embodiment, additional steps may be added, others removed, and the ordering of the steps may be changed.

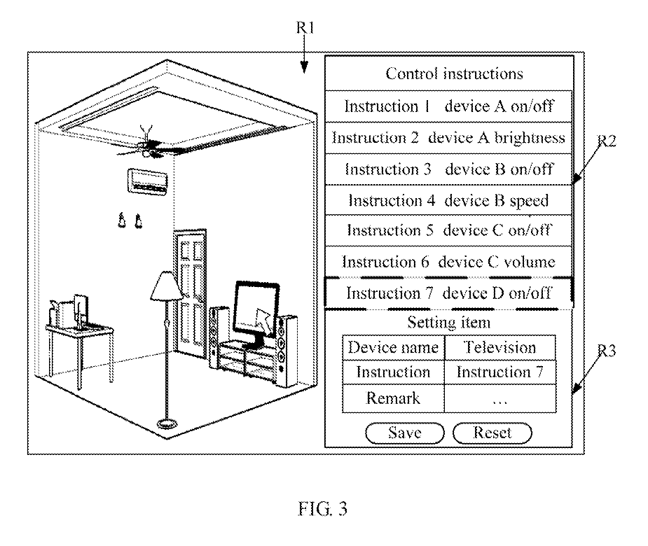

In step S21, the first display module 211 displays a simulation scene of a monitored place on the display device 24 of the control computer 2, and displays a setting interface on the display device 24 for setting control instructions for controlling electrical devices in the monitored place and setting associations between the control instructions and the electrical devices. For example, as shown in FIG. 3, there are three regions R1, R2, and R3. The R1 region displays the simulation scene of a living room in a house. The R2 region displays on the display device 24 a set of control instructions, such as an “instruction 1” for controlling on/off statuses of a device A and an “instruction 2” for adjusting brightness of the device A, for example. The R3 region displays a setting item, such as the setting item for setting an association between an instruction 7 shown in the R2 region and a television shown in the R1 region.

In step S22, the setting module 212 stores the control instructions and the associations between the control instructions and the electrical devices in the simulation scene into the storage device 22. In this embodiment, the setting of the associations may be achieved by dragging a selected instruction (such as a “Instruction 7”) by a tool (e.g., a finger or a stylus) to a graphic of a corresponding electrical device (such as a television). Then, the R3 region will display the setting item as shown in FIG. 3, and the setting item (i.e., the setting result) can be saved by clicking a “Save” button displayed in the R3 region. Alternatively, the setting of the associations may be achieved by directly inputting a device name (such as “Television”) and an identifier of an instruction (such as “Instruction 7”) in the R3 region.

In step S23, the download module 111 downloads the simulation scene of the monitored place from the control computer 2 to the computing device 1.

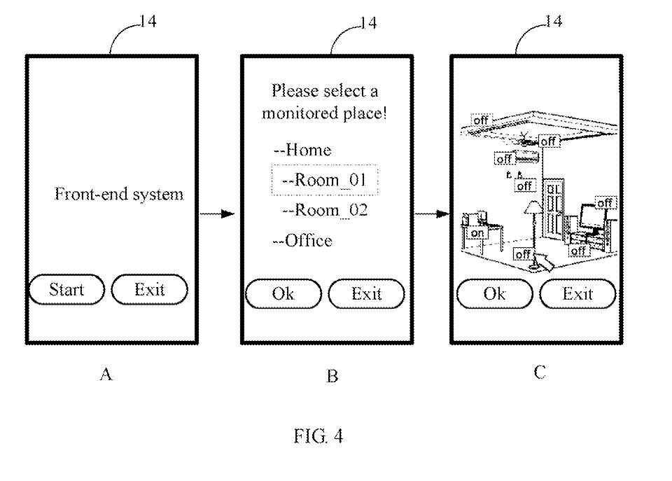

In step S24, the second display module 112 displays the simulation scene of the monitored place on the display device 14 of the computing device 1, and displays current statuses of the electrical devices in the monitored place in the simulation scene. For example, as shown in FIG. 4A-FIG. 4C, when the front-end system 11 is started in the computing device 1, a list including simulation scenes of one or more monitored places is displayed on the display device 14 for user to select one, such as “Room 1”, then graphics of electrical devices in the “Room 1” are displayed on the displayed device 14 as well as current statuses of the electrical devices in the “Room 1”.

In step S25, the second receiving module 113 receives a selection operation on an electrical device in the simulation scene and one or more control operations on control icons of the electrical device in the simulation scene to adjust a status of the selected electrical device. For example, as shown in FIG. 4C, the floor lamp is selected, and a floor lamp is at an “off” status. In FIG. 5, a control operation in relation to switching the floor lamp “on” and a control operation in relation to adjusting brightness of the floor lamp are detected.

In step S26, the second sending module 114 sends information in relation to the selection operation and the one or more control operations in the simulation scene to the control computer 2. The first receiving module 214 of the back-end system 21 receives the information in relation to the selection operation and the control operations in the simulation scene. The analysis module 215 determines an electrical device connected to the controller 3 according to the received information and one or more control instructions associated with the determined electrical device according to the associations stored in the storage device 22. Then, the first sending module 213 sends the determined control instruction to the controller 3 to control the status of the determined electrical device by executing the control instruction by the controller 3. For example, the “Instruction 1” and “Instruction 2” are sent to the controller 3, the controller 3 executes the “Instruction 1” and “Instruction 2” to switch the floor lamp 4 on and adjust brightness of the floor lamp 4.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a control computer for controlling one or more electrical devices connected to the control computer via a controller, the method comprising:
displaying a simulation scene of a monitored place on a display device of the control computer, and displaying a setting interface on the display device, the setting interface configured for setting control instructions to control one or more electrical devices in the monitored place and setting associations between the control instructions and the one or more electrical devices;
downloading the simulation scene of the monitored place from the control computer to a computing device via a network;
receiving from the computing device information in relation to a selection operation on an electrical device and one or more control operations on control icons of the selected electrical device in the simulation scene for adjusting a status of the selected electrical device;
determining an electrical device connected to the controller according to the received information and one or more control instructions associated with the determined electrical device according to the associations stored in a storage device; and
controlling the status of the determined electrical device by sending the one or more control instructions to the controller and executing the one or more control instructions by the controller.

2. The method of claim 1, wherein the simulation scene comprises graphics and the control icons of the electrical devices arranged in the monitored place and controlled by the controller.

3. The method of claim 1, further comprising: storing the control instructions and the associations between the control instructions and the electrical devices in the simulation scene into the storage device.

4. The method of claim 1, wherein the controller is a programmable automation controller (PAC) or a programmable logic controller (PLC).

5. A method being executed by a processor of a computing computer for controlling one or more electrical devices connected to a control computer via a controller, the method comprising:
downloading a simulation scene of a monitored place from the control computer to the computing device via a network, wherein the simulation scene comprises graphics and control icons of electrical devices arranged in the monitored place and controlled by the controller;
displaying the simulation scene of the monitored place on a display device of the computing device, and displaying current statuses of the electrical devices in the monitored place in the simulation scene;
receiving a selection operation on an electrical device in the simulation scene and one or more control operations on control icons of the selected electrical device in the simulation scene for adjusting a status of the selected electrical device; and
sending information in relation to the selection operation and the one or more control operations to the control computer, so that the control computer determines an electrical device connected to the controller and one or more control instructions associated with the determined electrical device according to preset associations between the electrical devices and the control instructions, and controls the status of the determined electrical device by sending the determined one or more control instructions to the controller.

6. The method of claim 1, wherein the preset associations between the electrical devices and the control instructions are set by the control computer and stored in a storage device of the control computer.

7. The method of claim 1, wherein the controller is a programmable automation controller (PAC) or a programmable logic controller (PLC).

8. A control computer for controlling one or more electrical devices connected to the control computer via a controller, the control computer comprising:
a storage device;
a processor;
one or more programs stored in the storage device and executed by the processor, the one or more programs comprising instructions to:
display a simulation scene of a monitored place on a display device of the control computer, and display a setting interface on the display device, the setting interface configured for setting control instructions to control one or more electrical devices in the monitored place and setting associations between the control instructions and the one or more electrical devices;
download the simulation scene of the monitored place from the control computer to a computing device via a network;
receive from the computing device information in relation to a selection operation on an electrical device and one or more control operations on control icons of the selected electrical device in the simulation scene for adjusting a status of the selected electrical device;
determine an electrical device connected to the controller according to the received information and one or more control instructions associated with the determined electrical device according to the associations stored in a storage device; and
control the status of the determined electrical device by sending the one or more control instructions to the controller and executing the one or more control instructions by the controller.

9. The control computer of claim 8, wherein the simulation scene comprises graphics and the control icons of the electrical devices arranged in the monitored place and controlled by the controller

10. The control computer of claim 8, wherein the one or more programs further comprise instructions to store the control instructions and the associations between the control instructions and the electrical devices in the simulation scene into the storage device.

11. The control computer of claim 8, wherein the controller is a programmable automation controller (PAC) or a programmable logic controller (PLC).

12. A computing device for controlling one or more electrical devices connected to a control computer via a controller, the computing device comprising:
a storage device;
a processor;
one or more programs stored in the storage device and executed by the processor, the one or more programs comprising instructions to:
download a simulation scene of a monitored place from the control computer to the computing device via a network, wherein the simulation scene comprises graphics and control icons of electrical devices arranged in the monitored place and controlled by the controller;
display the simulation scene of the monitored place on a display device of the computing device, and display current statuses of the electrical devices in the monitored place in the simulation scene;
receive a selection operation on an electrical device in the simulation scene and one or more control operations on control icons of the selected electrical device in the simulation scene for adjusting a status of the selected electrical device; and
send information in relation to the selection operation and the one or more control operations to the control computer, so that the control computer determines an electrical device connected to the controller and one or more control instructions associated with the determined electrical device according to preset associations between the electrical devices and the control instructions, and controls the status of the determined electrical device by sending the determined one or more control instructions to the controller.

13. The computing device of claim 12, wherein the preset associations between the electrical devices and the control instructions are set by the back-end system and stored in a storage device of the back-end system.

14. The computing device of claim 13, wherein the controller is a programmable automation controller (PAC) or a programmable logic controller (PLC).
